(19) United States
(12) Patent Application Publication
(10) Pub. No.: US 2010/0229898 A1
(43) Pub. Date: Sep. 16, 2010

(54) METHOD FOR CLEANING SURFACES OF POLYOLEFIN-BASED MATERIALS SOILED WITH FOOD, PARTICULARLY DAIRY PRODUCTS

(75) Inventors: Jean-Alex Laffitte, Pau (FR); Bernard Monguillon, Mourenx (FR)

Correspondence Address: ARKEMA INC.;PATENT DEPARTMENT - 26TH FLOOR, 2000 MARKET STREET, PHILADELPHIA, PA, 19103-3222, US

(73) Assignee: ARKEMA FRANCE, Colombes (FR)

(21) Appl. No.: 12/601,348

(22) PCT Filed: May 19, 2008
(86) PCT No.: PCT/FR2008/050856

§ 371 Date: Apr. 21, 2010

(30) Foreign Application Priority Data
May 24, 2007 (FR) 0755251

(51) Int. Cl. B08B 3/00; C11D 1/12

(52) U.S. Cl. 134/28; 510/219

(57) ABSTRACT

The invention relates to a method for cleaning surfaces of polyolefin-based materials soiled with food, particularly dairy products. More specifically, the invention relates to a method for cleaning materials based on one or more halogenated or non-halogenated polyolefins and soiled with food, particularly dairy products, which method is particularly safe for the environment, but also for the soiled polyolefin-based material with minimal wear and tear. According to the invention, the soiled material is brought into contact with an aqueous composition based on alkane sulfonic acids having between 1 and 4 carbon atoms.

### TECHNICAL FIELD

The present invention relates to the field of cleaning equipment in contact with food.

The term “cleaning” means the removal of soiling originating from this food, such as carbohydrates, fats, proteins, inorganic mineral constituents such as calcium carbonate, calcium phosphate or other types of tartar formed, for example, from oxalates, sulfates, hydroxides and/or sulfides combined with metals, metalloids or alkaline-earth metals, and other residues encountered in the food processing industry.

### PRIOR ART

For the cleaning of polyolefin-based equipment soiled with food, such as dairy products, the food processing industry and especially the dairy industry (cheese makers, etc.) use acid-based compositions for cleaning equipment (containers, filters, molds, etc.).

For example, for the cleaning of cheese molds made of polypropylene (PP) that are reused many times, the cheesemaking industry uses cleaning compositions based on inorganic acids, for instance phosphoric acid, sulfuric acid, sulfamic acid and/or organic acids, for instance citric acid or acetic acid.

The resistance of polyolefins such as PP or PE, polyvinyl chloride (PVC) or polytetrafluoroethylene toward acids such as sulfuric acid, phosphoric acid, nitric acid, acetic acid or citric acid at various concentrations and various temperatures has been studied. Data relating to the chemical resistance of PP to phosphoric acid, nitric acid, sulfuric acid, acetic acid and citric acid is found, for example, on the web site www.engineeringtoolbox.com:

| | |
|---|---|
| Composition | Rating¹⁾ |

| | | |
|---|---|---|
| (qs 100%: water) | 20° C. | 60° C. |

| | | | |
|---|---|---|---|
| H₃PO₄ | 25% | 1 | 1 |
| H₃PO₄ | 85% | 1 | 1 |
| HNO₃ | 5% | 2 | 3 |
| HNO₃ | 65% | 4 | 4 |
| H₂SO₄ | 10% | 1 | 1 |
| H₂SO₄ | 10% | 1 | 1 |
| H₂SO₄ | 78% | 2 | 4 |
| H₂SO₄ | 93% | 3 | 4 |
| Acetic acid | 10% | 1 | 1 |
| Citric acid | | 1 | 1 |

¹⁾rating: 1. Excellent (no attack); 2. Good (negligible attack); 3. Acceptable (weak attack, moderate use); 4. Unacceptable (significant attack); 5. Poor (tearing or dissolution possible)

or in the brochure from the company Schott entitled “Corrosion resistance of acid waste drainline piping and vent materials”:

| Composition (qs 100%: water) | | Rating²⁾ |
|---|---|---|
| H₃PO₄ | >45% at 27° C. | A |
| H₃PO₄ | <45% at 27° C. | A |
| H₃PO₄ | 100% at 80° C. | B |
| HNO₃ | concentrated at 80° C. | F |
| HNO₃ | diluted at 80° C. | B |
| H₂SO₄ | between 10 and 75% at 80° C. | C |
| H₂SO₄ | >10% at 80° C. | C |
| Acetic acid | 50% at 80° C. | A |

²⁾rating: A: very good; B: moderate; C: limited; F: unsatisfactory

However, organic acids such as acetic acid and citric acid cannot be used in a generalized manner on account of their weaker acidity and thus their poorer cleaning power.

As regards inorganic acids, it has been found that commercial cleaning compositions based on sulfuric acid and/or nitric acid have a tendency to attack the surfaces of polyolefin-based equipment in the course of successive cleaning, making it necessary to replace this with new equipment.

For phosphoric and/or sulfamic acid, although they have good cleaning power, taking into account the fact that contain phosphorus and nitrogen, respectively, they are generators of phosphates and nitrates, respectively, in discharges and there is a tendency to replace them for ecological reasons, since the European directives on the levels of phosphorus and nitrogen discharges into water courses are becoming increasingly stringent.

There is thus a need to replace these cleaning compositions based on phosphoric acid and/or sulfamic acid and/or nitric acid and/or sulfuric acid, generally employed in temperature ranges generally ranging from 10 to 90° C., with other technical solutions that are both more environmentally friendly and more friendly to polyolefin-based soiled equipment that it is desired to clean within similar temperature ranges.

### DESCRIPTION OF THE INVENTION

The present invention proposes a process for cleaning polyolefin-based equipment soiled with food and more particularly with dairy products, characterized by the use of aqueous cleaning compositions that do not degrade the surface of the polyolefin-based equipment and are free of nitrogen and phosphorus.

The cleaning compositions used in the process according to the invention especially contain one or more short-chain alkanesulfonic acids containing from 1 to 4 carbon atoms and preferably contain methanesulfonic acid (MSA).

In general, the compositions of the invention contain from 0.5% to 100%, in particular from 0.5% to 20% and more particularly 0.5% to 5% by weight of alkanesulfonic acid(s).

They are often prepared in the form of a concentrated mixture that is diluted by the final user.

Besides the alkane sulfonic acid(s), the cleaning compositions optionally contain one or more co-solvents, one or more water-miscible co-acids (for instance sulfuric acid, sulfamic acid or citric acid), optionally one or more thickeners, optionally one or more surfactants and optionally various other additives such as foaming agents, foam stabilizers, etc.

in the cleaning process according to the invention, the contact of the polyolefin-based equipment and the cleaning composition is generally performed between 10 and 90° C. for a time generally ranging from about one minute to a few tens of minutes. The equipment is then generally rinsed with water to remove the cleaning composition remaining on the equipment that has just been cleaned, and it is dried, for example in the open air.

Such alkanesulfonic acid-based cleaning compositions are described, for example, in EP 271 791 B1 and in CA 2 499 592 A1 in which they are used only for cleaning metal objects (copper, aluminum, steel) and glass flasks.

For the purposes of the present invention, the term “polyolefin(s)” means α-olefin or diolefin homopolymers or copolymers, for instance ethylene, propylene, 1-butene, 1-octene and butadiene, alone or as a mixture.

Examples of α-olefins containing 3 to 30 carbon atoms as possible comonomers include propylene, 1-butene, 1-pentene, 3-methyl-1-butene, 1-hexene, 4-methyl-1-pentene, 3-methyl-1-pentene, 1-octene, 1-decene, 1-dodecene, 1-tetradecene, 1-hexadecene, 1-octadecene, 1-eicosene, 1-docosene, 1-tetracosene, 1-hexacosene, 1-octacosene and 1-triacontene. These α-olefins may be used alone or as a mixture of two or more than two.

Examples of polyolefins that may be mentioned include:
ethylene homopolymers and copolymers, and in particular, as examples of polyethylenes, mention may be made of:
low-density polyethylene (LDPE)
high-density polyethylene (HDPE)
linear low-density polyethylene (LLDPE)
very low-density polyethylene (VLDPE)
polyethylene obtained by metallocene catalysis, i.e. polymers obtained by copolymerization of ethylene and an α-olefin such as propylene, butene, hexene or octene in the presence of a single-site catalyst generally formed from a zirconium or titanium atom and two cyclic alkyl molecules bonded to the metal. More specifically, metallocene catalysts are usually composed of two cyclopentadiene rings bonded to the metal. These catalysts are frequently used with aluminoxanes as co-catalysts or activators, preferably methylaluminoxane (MAO). Hafnium may also be used as a metal to which cyclopentadiene is bound. Other metallocenes may include transition metals from the groups IV A, V A and VI A. Metals of the lanthanide series may also be used.
propylene homopolymers or copolymers.
ethylene/α-olefin copolymers such as ethylene/propylene, EPR (abbreviation for ethylene-propylene-rubber) and ethylene/propylene/diene (EPDM).
styrene/ethylene-butene/styrene (SEBS), styrene/butadiene/styrene (SBS), styrene/isoprene/styrene (SIS), styrene/ethylene-propylene/styrene (SEPS) block copolymers.
copolymers of ethylene with at least one product chosen from the salts or esters of unsaturated carboxylic acids, for instance alkyl (meth)acrylates, the alkyls possibly containing up to 24 carbon atoms.

For the purposes of the present invention, the term “polyolefins” also means halogenated polyolefins such as plasticized or non-plasticized, perchlorinated or non-perchlorinated polyvinyl chloride (PVC), polytetrafluoroethylene (PTFE) and polyvinylidene fluoride (PVDF), alone or as a mixture with one or more other halogenated or non-halogenated polyolefins.

### Examples

### Study of the Aging of Polypropylene Molds by Immersion at 70° C.

1) Immersion Tests

Conditions of the Immersion Wear Test

A 1 L bottle filled with a solution of phosphoric acid or of methanesulfonic acid at 1% by weight is immersed in a bath stirred at 70° C., and a polypropylene PP mold plate of dimensions 3 cm×3 cm×0.5 cm is introduced therein and left for 15 days. The plate is then removed, rinsed with distilled water at room temperature, and then dried in the open air for 4 hours, followed by taking measurements by AFM (atomic force microscopy) in intermittent contact mode, which makes it possible to obtain a microscopic image of the surface of the probed sample and to give quantitative measurements of the surface quadratic roughness. The lower the roughness, the greater the wear and the degradation.

Measurement of Roughness by AFM

The roughness of each sample is calculated automatically by means of computer software. There are two roughness values: the quadratic roughness (Rq) and the average roughness (Ra). We arbitrarily chose to compare our samples on the basis of the quadratic roughness.

The quadratic roughness (Rq), expressed in nanometers, corresponds to the standard deviation of the values of Z (height of the sample at a point relative to any reference) on a surface. It is calculated by the following relationship:

$$Rq = \sqrt{\frac{\sum {( Zi - {Z}_{M} )}^{2}}{N}}$$

in which
Zi is the value of Z at a point i on the surface (in nm),
Z_{M} is the mean value of Z on a given surface (in nm),
N is the number of points analyzed in this surface

Rq thus expresses the microrelief of the surface: the lower its value, the smoother and the more worn the surface.

The roughness measurements RQ (average of three measurements), and thus the wear by immersion, are expressed by the ratio of the roughness at time t to the initial roughness, in Table 1:

TABLE 1

| | Roughness at time t/initial | Roughness at time t/initial |
|---|---|---|
| | roughness with | roughness with |
| Aging time | aqueous 1% MSA solution | aqueous 1% H₃PO₄ solution |
| 0 | 100% | 100% |
| 15 days | 78% | 57% |

A smaller reduction in roughness and thus less wear of the PP plate is observed with the aqueous MSA solution compared with the aqueous H₃PO₄ solution.

2) Spraying Tests

Conditions of the Spraying Wear Test

In cheesemaking factories, the cleaning solution is sprayed under pressure. In order optimally to simulate these cleaning conditions, a spray-induced aging system that is more severe than the preceding immersion experimental conditions is established.

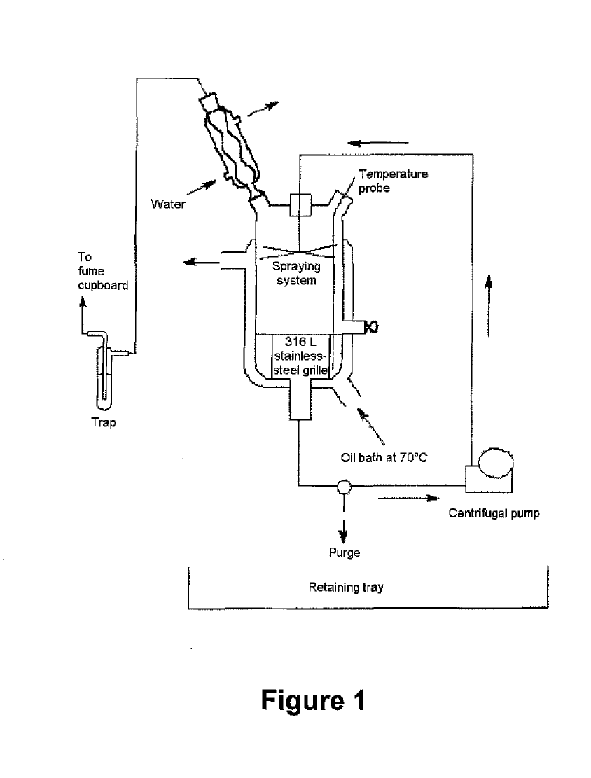

To do this, a jacketed reactor coupled to a thermostatically maintained oil bath is used. The test molds are chopped into plates with a side length of 3 cm×3 cm×0.5 cm and these plates are then placed on a 316L stainless-steel grille is about 5 cm from the bottom of the reactor. The test solution is then circulated using a centrifugal pump. The plates are thus sprinkled with the solution according to the scheme in FIG. 1.

The test cleaning compositions contain, respectively, 1% methanesulfonic acid or 1% phosphoric acid (the rest being water) and are placed in contact with the PP at 70° C. for a duration of 4 and 6 days. After this spraying time, the plate is then removed, rinsed with distilled water at room temperature, and then dried in the open air for 4 hours, and the AFM measurements are then taken.

Table 2 below collates the roughness measurements taken on the polypropylene mold samples placed in contact with the cleaning solutions by spraying. These measurements are expressed by the ratio of the roughness at time t to the initial roughness:

TABLE 2

| | Roughness at time t/initial | Roughness at time t/initial |
|---|---|---|
| Aging time | roughness | roughness |
| in days | with 1% MSA solution | with 1% H₃PO₄ solution |
| 0 | 100% | 100% |
| 4 days | 72% | 68% |
| 6 days | 71% | 62% |

Whether by immersion or by spraying, it is found that the MSA-based compositions wear the polypropylene molds less than the phosphoric acid-based compositions.

1. A process for cleaning polyolefin-based equipment soiled with food, characterized by contacting the polyolefin-based equipment soiled with food with an aqueous cleaning composition containing one or more short-chain alkanesulfonic acids containing from 1 to 4 carbon atoms.

2. The process as claimed in claim 1, characterized in that the cleaning compositions contain composition contains from 0.5% to 100% by weight of alkanesulfonic acid.

3. The process as claimed in claim 1, characterized in that the composition further contains an additive selected from the group consisting of one or more co-solvents, one or more water-miscible co-acids, one or more thickeners, one or more surfactants foaming agents, foam stabilizers and mixtures thereof.

4. The process as claimed in claim 1, characterized in that the polyolefin-based equipment contains polypropylene (PP).

5. The process as claimed in claim 1, characterized in that the process is performed at between 10 and 90° C.

6. The process of claim 1 wherein said contacting takes place for more than about one minute.

7. The process of claim 1 wherein said contacting is followed by rinsing followed by drying.

8. The process of claim 1 characterized in that said short-chain alkanesulfonic acid containing from 1 to 4 carbon atoms is methanesulfonic acid (MSA).

9. The process as claimed in claim 1, characterized in that the cleaning composition contains from 0.5% to 20% by weight of alkanesulfonic acid.

10. The process as claimed in claim 1, characterized in that the cleaning composition contains from 0.5% to 5% by weight of alkanesulfonic acid.

11. The process of claim 1 wherein said food comprises-dairy products.
